(19) United States
(12) Patent Application Publication
(10) Pub. No.: US 2024/0217629 A1
(43) Pub. Date: Jul. 4, 2024

(54) OFFSHORE SUBMERGIBLE PLATFORM

(71) Applicant: A.H. Beck Foundation Co., Inc., Converse, TX (US)

(72) Inventor: August Henry Beck, III, San Antonio, TX (US)

(73) Assignee: A.H. Beck Foundation Co., Inc., Converse, TX (US)

(21) Appl. No.: 18/401,407

(22) Filed: Dec. 30, 2023

Related U.S. Application Data
(60) Provisional application No. 63/436,540, filed on Dec. 31, 2022.

(51) Int. Cl. B63B 35/44; B63B 5/14; B63B 21/50; B63B 75/00

(52) U.S. Cl. CPC B63B 35/44; B63B 5/14; B63B 21/502; B63B 75/00; B63B 2035/446

(57) ABSTRACT

An offshore submergible platform system and methods of manufacturing and installing same is disclosed. The system comprises a platform comprising concrete and a buoyant foam suitable to provide the required buoyancy to allow the platform to float, a template slab for placing on the ocean floor and positioning the system components in the proper location, a plurality of anchored tension legs which are preferably grouted into the ocean floor at installation, a stub tower preferably cast on top of the platform, and a plurality of cable braces preferably forming an X between the platform and the bottom of the anchor legs. Preferred embodiments can include additional lateral anchor ties and a work platform to be positioned atop the stub tower.

### CROSS-REFERENCE TO RELATED APPLICATIONS

This application claims priority to U.S. Provisional Application No. 63/436,540 (“the '540 Application”) filed Dec. 31, 2023. The '540 Application is hereby incorporated by reference in its entirety for all purposes, including but not limited to, all portions describing the manufacturing process and equipment of the present invention and the embodiments disclosed, those portions describing offshore platforms in general as background and for use with specific embodiments of the present invention, and those portions describing other aspects of manufacturing and testing of offshore platforms that may relate to the present invention.

### STATEMENTS REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

### 1. Field of the Invention

The present invention relates to a submergible offshore platform. More particularly, the present invention relates to a submergible offshore platform comprised of reinforced cementitious material (concrete, shotcrete or gunite). Even more particularly, the present invention relates to a submersible platform for supporting power generating wind turbines in offshore waters.

### 2. Description of the Related Art

Offshore wind power or offshore wind energy is the energy taken from the force of the winds out at sea, transformed into electricity and supplied into the electricity network onshore. Because the winds offshore typically have higher wind speeds, they are generally thought to generate more power than land-based wind turbines. Also, offshore wind turbines do not suffer from space constraints or conflicts with local populations as land-based wind power generation systems. Despite these advantages, offshore wind power systems are typically more expensive to build and maintain. Therefore, there is a true need for cost effective and reliable offshore wind energy generations systems.

The main concepts for offshore wind power are well known in the oil and gas sector, where they are deployed commercially at a large scale. Platform designs for offshore wind, however, require adaptation to accommodate different dynamic characteristics and a distinct loading pattern. Most of today's offshore wind turbines are rooted to the seabed by monopile or jacket foundations and are restricted to shallow waters less than 50 meters deep. Floating foundations, by eliminating the depth constraint and easing turbine set-up, could open the way for power generation from deeper waters.

The three main existing concepts for floating foundations are spar-buoy, semi-submersible and tension leg platform. A spar buoy is a cylinder with low water plane area, ballasted to keep the center of gravity below the center of buoyancy. The foundation is kept in position by catenary or taut spread mooring lines with drag or suction anchors. A semi-submersible (or “spar-submersible”) platform is a number of large columns linked by connecting bracings/submerged pontoons. The columns provide the hydrostatic stability, and pontoons provide additional buoyancy. The foundation is kept in position by catenary or taut spread mooring lines and drag anchors. Finally, the tension leg platform is highly buoyant, with central column and arms connected to tensioned tendons which secure the foundation to the suction/piled anchors. Detailed descriptions of the existing technology can be found in IRENA (2016), Floating Foundations: a Game Changer for Offshore Wind Power, International Renewable Energy Agency, Abu Dhabi which is hereby incorporated by reference in its entirety for purposes of describing the current art.

A completely different area of technology called Lift slab refers to a method of construction of multi-story structures, that involves the placement of several concrete slabs on the ground. These slabs of concrete are then lifted to their designated, designed elevations. The lift slab method involves the erection of steel columns supported on concrete footings and piers. The slabs are then formed around these steel columns with bond breaker membranes placed between each of the slabs cast on the ground. The appearance of the structure appears like a multi layered birthday cake with several slabs placed, one over the other. The slabs are then lifted by hydraulic jacks. As the bottom slab of the group reaches its designated, designed elevation, it is wedged off at the columns, and dropped off from the pile of slabs. This procedure continues until all slabs are dropped off and the final slab becomes the roof slab. The advantage of this system is obvious, time, money and the expediency and ease of placing concrete slabs at grade elevation. Unfortunately, this method of construction fell in disfavor in the United States due to a catastrophe that occurred in Bridgeport Ct. The lift slab technique was extremely popular, however a structure collapsed in Bridgeport killing 28 workers. The rescue efforts of the local municipality were highly publicized, and the end result was the restricted use of the lift slab technique in the United States. Although the technique was a unique system of construction and resulted in millions of square feet of successful, stable and long-lasting structures, the lack of proper safety procedures and a possible unrelated failure resulted in the restricted use of this construction technique. It would be desirable to find a useful and safe way to utilize Lift-Slab equipment and techniques for another purpose.

### BRIEF SUMMARY OF THE INVENTION

The present invention is offshore submergible platform system and methods of manufacturing and installing same. The system comprises a platform comprising concrete and a buoyant material suitable to provide the required buoyancy to allow the platform to float, a template/anchor slab for placing on the ocean floor and positioning the system components in the proper location, a plurality of anchored tension legs which are preferably grouted into the ocean floor at installation, a stub tower preferably cast on top of the platform, a plurality of cable braces preferably forming an X between the platform and the exposed bottom of the anchor legs. Preferred embodiments can include additional lateral tie anchors and a work platform to be positioned atop the stub tower.

Preferably, the method of installing the offshore platform system comprises casting the concrete and polymer platform with a stub tower onshore, towing the platform out to sea, placing the template slab in position, drilling into the ocean floor, and securing the tension legs to the ocean floor (for example with grout and/or helix anchors) and submerging the platform utilizing modified lift slab technique and installing an optional work platform above the ocean atop the stub tower.

Additional advantages of the invention are set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

A better understanding of the present invention can be obtained when the following detailed description of the disclosed embodiments is considered in conjunction with the following drawings in which:

FIG. 1 is an elevation view of an embodiment of the offshore submerged platform system after installation;

FIG. 2 is a perspective view of an embodiment of the platform with a stub tower utilized in the offshore submerged platform;

FIG. 3 is an elevation view of another embodiment of the offshore submerged platform system with a work platform atop the stub tower;

FIG. 4 is an elevation view of another embodiment of the offshore submerged platform system utilizing additional external bracing;

FIG. 5 is an elevation view of an embodiment of the platform along with template/anchor slap as utilized in an embodiment of a submerged offshore platform;

FIG. 6 is a top view of the platform of FIG. 5;

FIG. 7 is an elevation view of another embodiment of the offshore submerged platform system;

FIG. 8 is an elevation view of another embodiment of the platform along with template/anchor slap as utilized in an embodiment of a submerged offshore platform;

FIG. 9 is a top plan view of an embodiment of a platform with stub tower and tower crane showing the temporary steel column and lifting slab head connection as could be utilized to submerge the platform;

FIG. 10 is an elevation view of the embodiment of a platform of FIG. 9.

FIG. 11 is an elevation view of an embodiment of an offshore submersible platform system that is circular utilizing a wind turbine for generating power;

FIG. 12 is a top view of a section of the circular platform of FIG. 11;

FIG. 13a/b are side view and top view of an embodiment of platform having self-propelling forward and rearward barge sections attached;

FIG. 14a/b are side view and top view of an embodiment of a platform having self-propelling forward and rearward barge sections attached;

FIG. 15a/b are side view and top view of an embodiment of a platform with a wind turbine attached onshore and having self-propelling forward and rearward barge sections attached; and

FIG. 16a/b are side view and top view of an embodiment of a self-propelling forward and rearward barge sections having been removed from the platform and attached to each other for return.

### DETAILED DESCRIPTION OF THE INVENTION

The present invention is an offshore submergible platform system and methods of manufacturing and installing same. The system comprises a platform comprising cementitious material (such as, concrete, shotcrete or gunite) and a buoyant material suitable to provide the required buoyancy to allow the platform to float, a template/anchor slab for placing on the ocean floor and positioning the system components in the proper location, a plurality of anchored tension legs which are preferably secured into the ocean floor at installation (preferably with grouting or helix pile anchors or both), a stub tower preferably cast on top of the platform, a plurality of cable braces preferably forming an X between the platform and the exposed bottom of the anchor legs. Preferred embodiments can include additional lateral ties and a work platform to be positioned atop the stub tower.

Preferably, the method of installing the offshore platform system comprises casting the concrete and polymer platform and stub tower onshore, towing the platform out to sea, placing the template/anchor slab in position, drilling into the ocean floor and securing the tension legs to the ocean floor with grout or helix anchors, submerging the platform utilizing lift slab technique, installing an optional work platform above the ocean atop the stub tower.

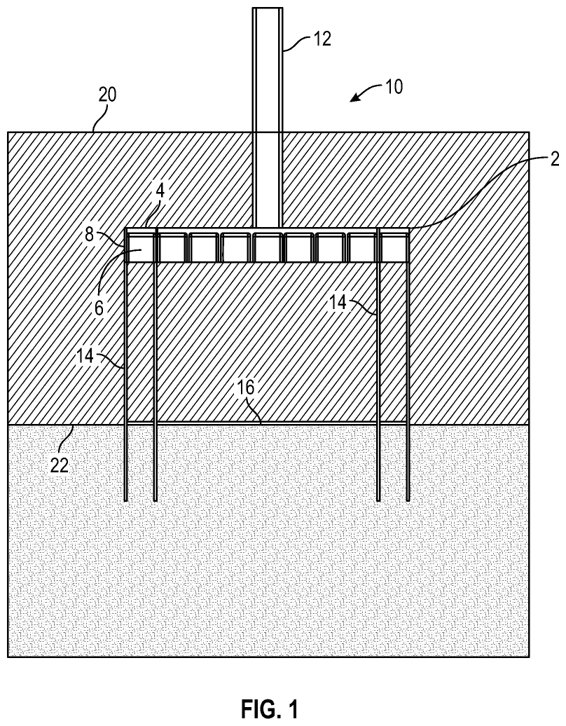

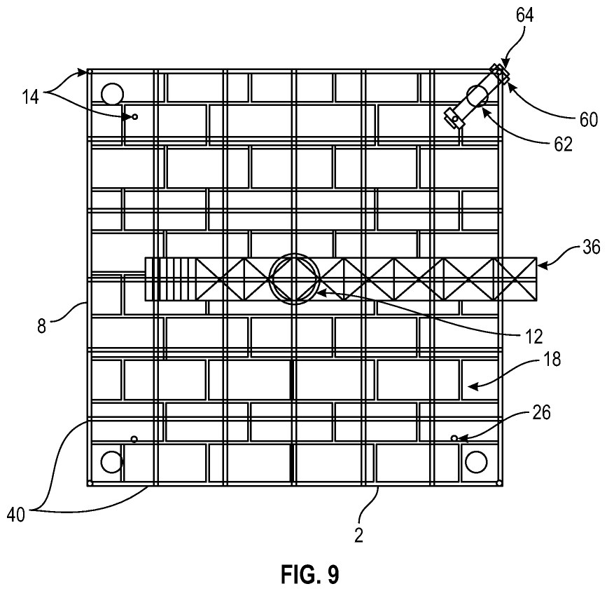

As shown in FIG. 1, the buoyant submerged platform preferably comprised concrete and a polymer such as polystyrene, polyurethane foam, or other open celled or hydrocarbon based buoyant materials. Preferred embodiments of the platform are about 110 to 170 feet by 110 to 170 feet by 10 to 30 feet, particular preferred embodiments are about 118 feet by 118 feet by 20 feet and 160 feet by 160 feet by 25 feet. As shown in FIG. 9, preferably the internal portion of the concrete platform is hollow and comprises one large cell group of smaller cells. The cell(s) would preferably have a structural top slab and surrounded on the sides by concrete wall(s) approximately 8″ to 12″ thick. As will now be recognized by a person of skill in the art, the top slab is designed to transmit the loads of the wind turbine assembly to the anchor legs and buoyant force pushing up. The plan view of the platform could also be round, triangular or have more than four sides, i.e., six sided or eight sided, etc. Preferably, the platform includes blockouts at the perimeter, for example in the corners,

Preferably, the template/anchor slab is cast on shore with the platform and lowered to the sea floor. The template/anchor slab is preferably cast with blockouts and inserts. The template/anchor slab is preferably the same or near the same outside dimension as the top slab on the platform and will preferably be around 12″ thick. Depending upon the dimensions of the platform, the template/anchor slab could weigh over 2,000,000 lbs. The template/anchor slab is preferably cast with blockouts for the anchor leg casing and anchors. Preferably, the template/anchor slab will also have inserts for the X bracing cables and for lowering to the sea floor. The template/anchor slab should also help protect the platform during towing. In preferred embodiments the surface dimensions of the template anchor slab will generally match the surface dimensions of the platform, for example 118×118 feet.

The polymer, preferably polystyrene, will typically come in 4′×4′×26′ or 32′ ingots. In one preferred method of making the platform, after the template/anchor slab is cast, the polystyrene ingots are preferably stacked on top of the slab some 20′ high. The exterior walls of the platform can then be cast against the polystyrene. The polystyrene acting as an inside form for the walls. The walls could be cast in place with concrete for example, or shotcrete or gunite similarly to the use in retaining wall and swimming pool construction. In one embodiment, horizontal tension rods can be sandwiched both ways between the ingots across the platform dimension to give lateral strength to the walls. The top slab can then be cast on top of the polystyrene ingots. Some of the ingots can be carved and/or spaced apart for aiding in the structural design of the top slab to form beams to minimize thickening of the top slab that supports the tower. Inserts can also be carved in the ingots for different purposes such as inserts block outs for the tension anchors. Other buoyant material could be used like closed cell foams.

As will now be recognized by a person of ordinary skill in the art, the exact dimensions for the platform and the amount and configuration of hydrocarbon polymer can be varied but the combination should be calculated to provide adequate buoyancy to float the platform on the ocean waters and support the turbine loads after submergence.

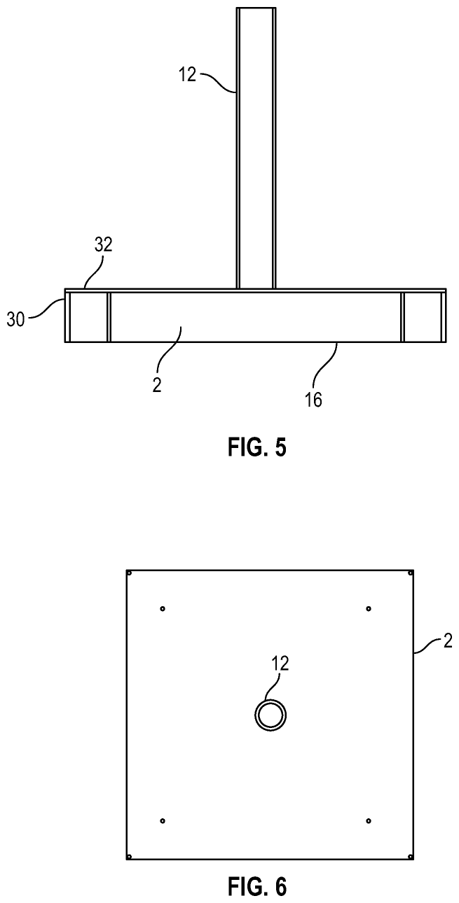

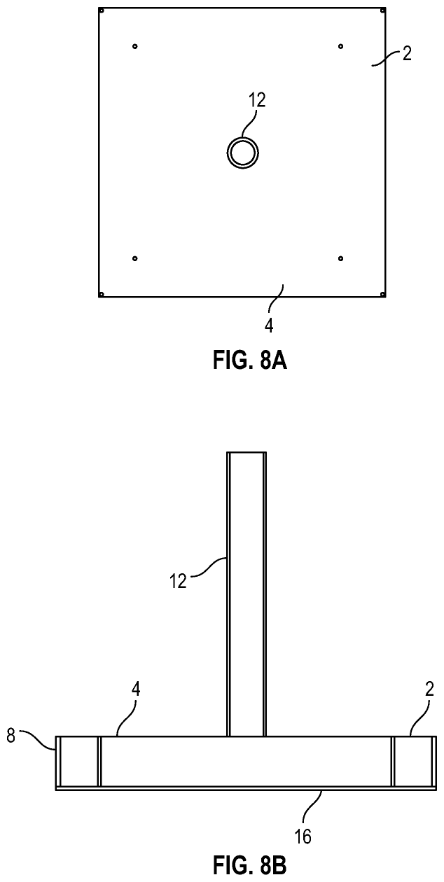

As shown in FIGS. 5 and 8, once prepared, the template slab is preferably temporarily attached to the platform for transport. The platform and template slab can be towed out to sea to the desired location for the installation. As will now be recognized by a person of skill in the art, the platform can be towed utilizing conventional barge and towing techniques.

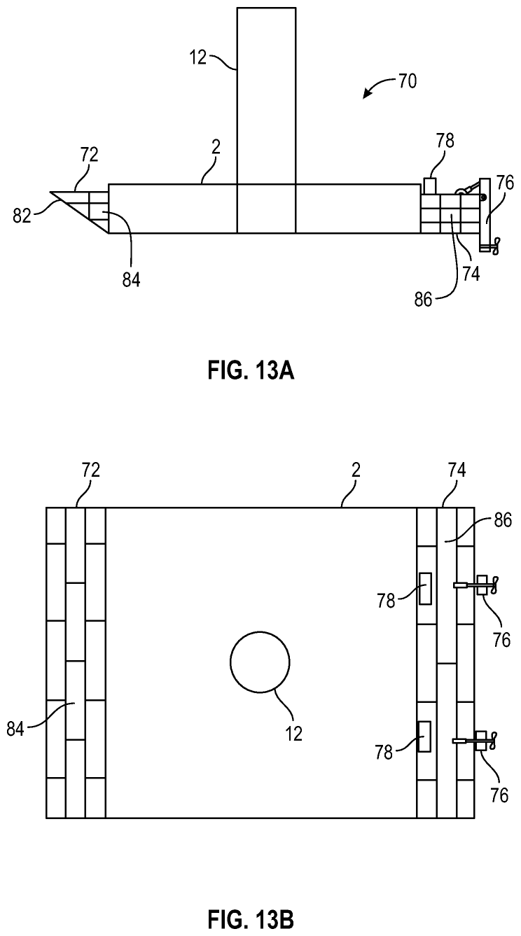

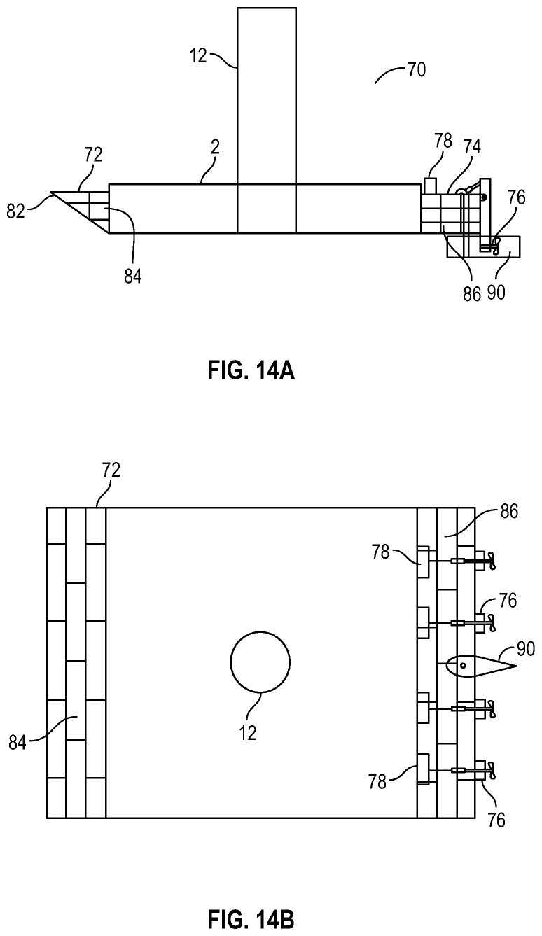

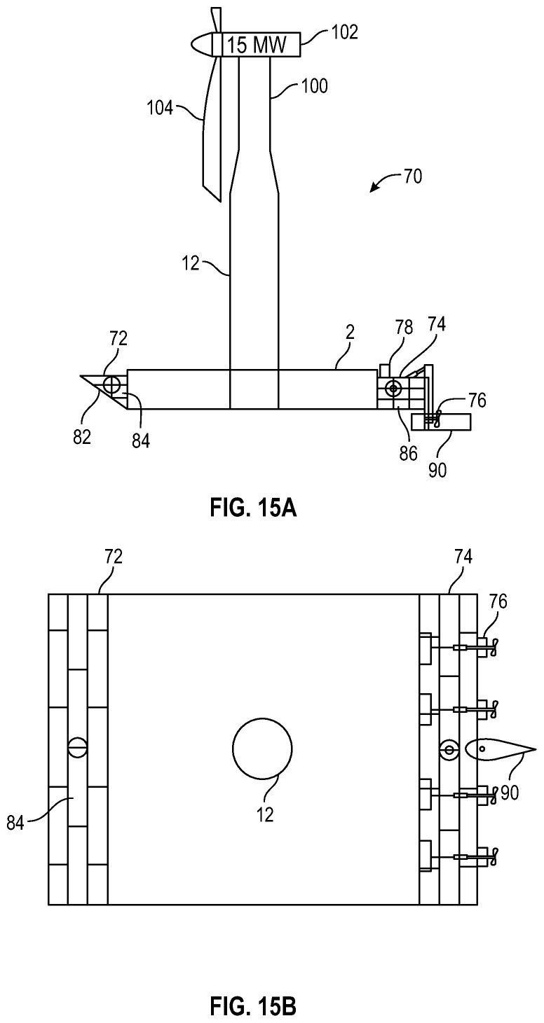

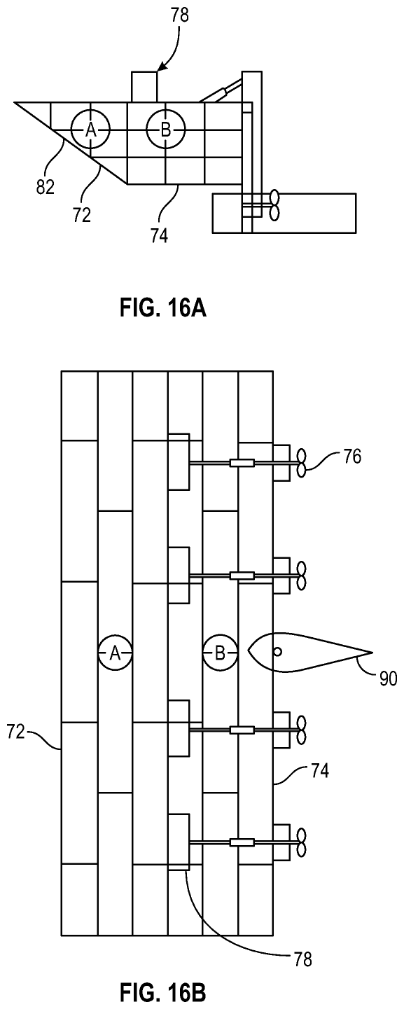

In one preferred embodiment, rather than being towed, the platform is transformed into a self-propelled and self-erecting system that needs no offshore assistance. As shown in FIG. 13-16, a forward barge section and a rearward barge section can be added, temporarily or permanently to the platform. In preferred embodiments, the forward section having a generally triangular cross section and the rearward section having rectangular cross section. Preferably, the rearward section has at least one rudder and at least one prop to provide propulsion. Preferred embodiments include a plurality of probs, most preferably about four. In general, the width of the forward barge section and the reward barge sections will about match the width of the platform. As shown in FIG. 16, in preferred embodiments the forward barge section and the rearward barge section can be removed from the platform and jointed together to return to the port for reuse on another system.

Once the platform is in the preferred position, the template slab is lowered into position on the sea floor. The template slab is placed on the ocean floor to help in the exact placement of the tension legs. Most preferably, the template slab is lowered in place with the lift slab equipment or other means in a controlled lowering. Preferably, as the template/anchor slab is lowered, steel casing (10¾″ or 13⅜″ dia) will be lowered with it. Additional casing will be added as the template/anchor slab is lowered. Alternatively, lowering the template/anchor slab can be done with the casing to the ocean floor. Once on the floor, then further advancing the casing into the ocean floor to act as a surface casing to drill thru to captivate the drilling mud and captivate the grout above the ocean floor. The bottom of the casing can be optionally equipped with weld-on helix flights to help secure the casing and the template/anchor slab. The helixed casing could also be used to help secure the platform for the drilling and grouting of the anchors. Preferably, casing and tension legs (drill pipe) are oilfield type. Preferably, the casing and the tension legs can be made up with oilfield make up tools, elevators, bails, bowls and slips. Preferably, slips and bowls will be used for the lift slab submerging operation and be incorporated in the final position of the submerged platform.

Once the template slab is in position, holes will be drilled into the ocean floor through the template/anchor leg block outs to secure the anchors. The anchors are preferably tension legs that are grouted into the drilled holes in the sea floor.

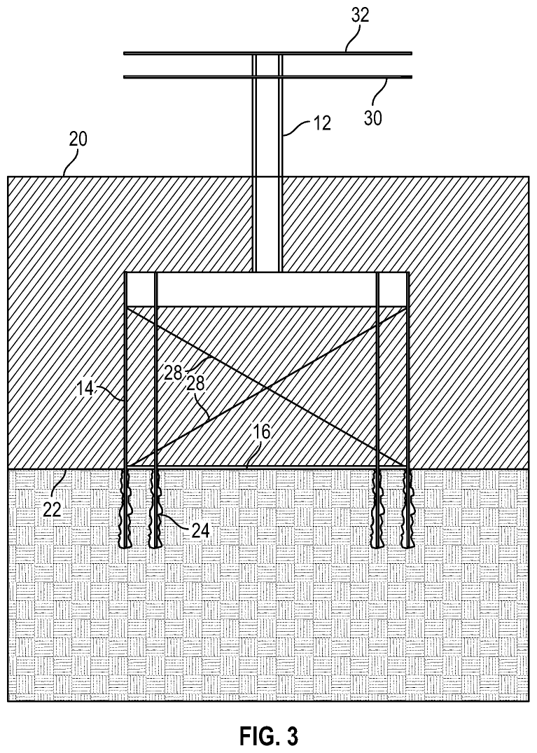

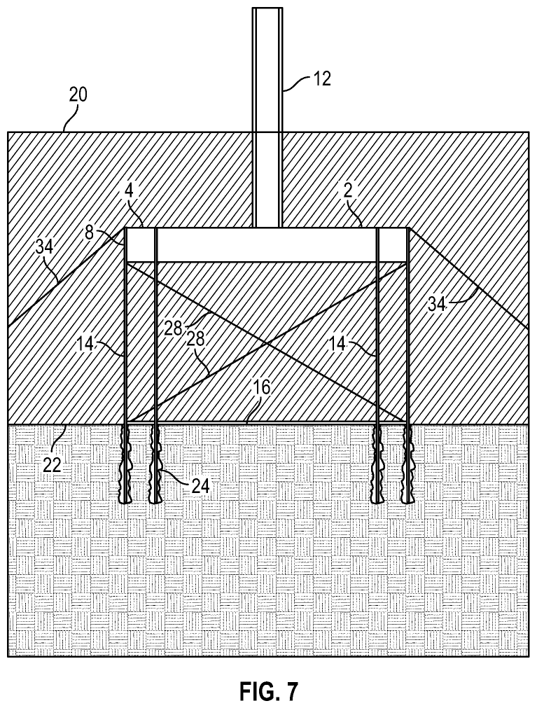

As shown in FIGS. 3, 4, 7 and 11, once the tension leg anchors are grouted into the ground, then preferably some X bracing and/or lateral support will be added. X bracing as shown is cable but as a person skilled in the art will now recognize, other means can be utilized.

Once the platform is properly anchored the platform will be submerged. Preferably, the platform is submerged using modified Lift Slab techniques as discussed herein to force the surface of the platform deep enough to be below any maximum storm wave trough, preferably at least forty feet below the surface. There are other techniques used to raise and lower heavy loads, for example, heavy loads like concrete slabs and beams and bridge spans, in a controlled manner that can also be utilized. These techniques can have the same result as a “lift slab” and these techniques can also be used to submerge the platform. As a person of skill in the art will now recognize, the modified Lift Slab technique preferably involves utilizing temporary steel columns approximately 6′ to 8′ in diameter X approximately 50′ long and placed preferably between two anchor legs. Lift slab equipment can be mounted on top of the columns. Generally, the lift slab equipment will pick up on the in-place anchor legs and pull upon the anchor legs (which won't move) and will thusly push down on the columns that will push down on the platform. Preferably, the anchors comprise standard oilfield drill pipe with a cutting shoe. The drill pipe preferably become the anchor. Bowls and slips let the platform go down but will not let the platform come up, similarly to when in the oilfield a connection is made for adding the next drill pipe or tripping out. Once the platform is in final position, the bowls and slips could become sacrificial and used to hold the platform in place or, alternatively, another type of connection can be utilized.

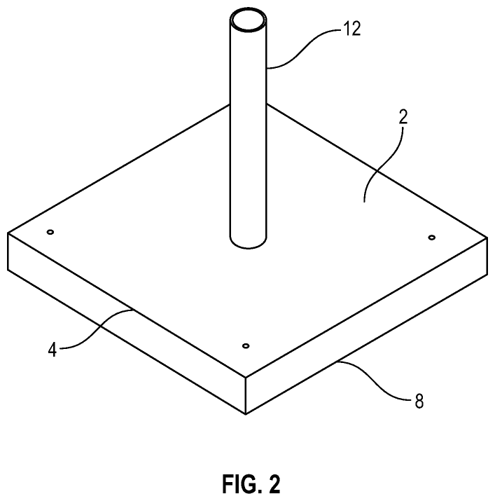

As shown in FIGS. 1 and 2, preferably a stub tower is cast on and into the top of the platform. Preferably, the stub tower comprises slip formed concrete, but it could also be a steel cylinder or a structural steel lattice. In some embodiments, the stub tower could be equipped with a tower crane like a construction tower crane that could be used for the installation of the tension leg anchors and lift slab submergence. The inside hollow portion of the stub tower that is submerged below the water surface can be filled with polystyrene or a closed cell foam for maintaining added buoyancy. Preferably, the stub tower is about 75 to 150 feet in height beyond the surface of the platform, most preferably about 90 feet. Depending upon the particular usage of the stub tower, the diameter can vary significantly, generally from about 12 to about 30 feet is preferred.

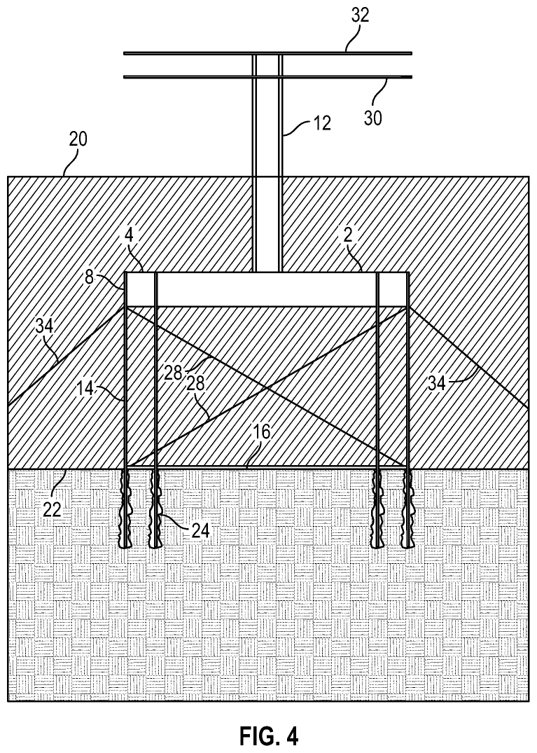

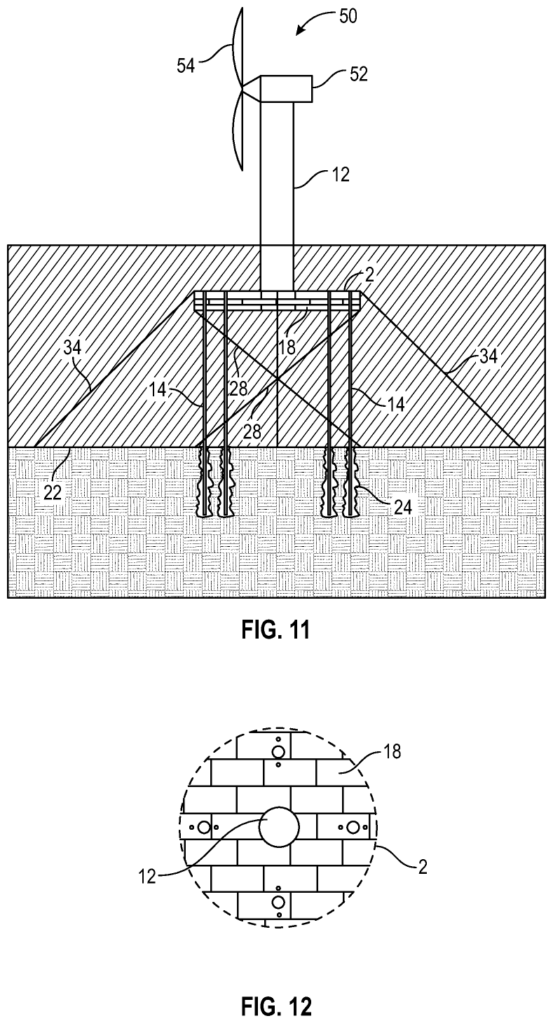

As shown in FIG. 11, in the case of utilizing the offshore submerged platform system for wind power generation, the stub tower will be used to support a wind turbine tower and generator for offshore electrical generation. The dimensions of the platform and stub tower can be adapted by a person of skill in the art to suit the requirements of a specific wind turbine or other equipment being utilized. A windmill contractor can also mount a windmill tower to the top of the stub tower and complete the installation of the wind turbine. Alternatively, a variety of work platforms such as shown in FIGS. 3 and 4 that might be needed near the top of the stub tower can be cast concrete along with the stub tower. Alternatively, the work platforms can be cast on the deck of the platform and raised into place with the lift slab equipment. The work platforms can be utilized independently or in conjunction with the wind power generation system.

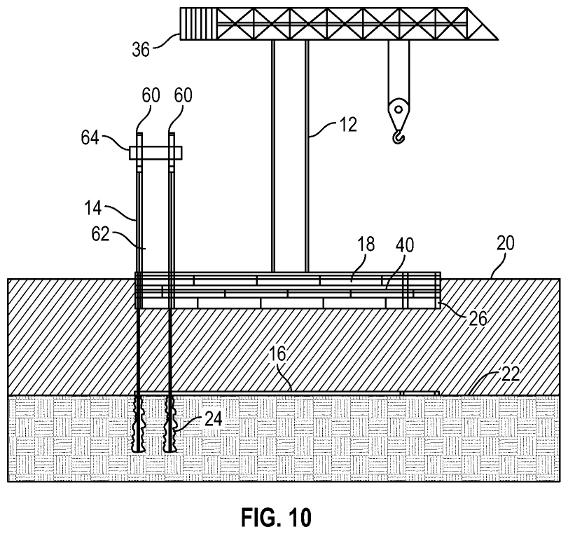

While the specific embodiment of the offshore submerged platform system shown is primarily for wind power generation, a person of skill in the art will now recognize that the platform system can be utilized for other offshore use such as oil and gas platforms and/or offshore housing and staging. In one particular embodiment, the offshore submerged platform system can be utilized to house large numbers of people in communities in international waters. Additionally, as shown in FIGS. 9 and 10, a tower crane can be affixed, temporarily of permanently depending upon the need, to the top of the stub tower.

As a person of ordinary skill in the art will now recognize, the offshore submerge platform system can be utilized in virtually any depth of waters where a platform is needed and the depth and other dimensions shown and discussed are purely exemplary. A person of ordinary skill in the art will now recognize that the dimensions can be adjusted based upon depth, application, location, and other factors. This offshore submerged platform system is however especially advantageous for deep water installations as compared to current technologies.

While the terms used herein are believed to be well-understood by one of ordinary skill in the art, definitions are set forth to facilitate explanation of certain of the presently-disclosed subject matter. Following long-standing patent law convention, the terms “a”, “an”, and “the” refer to one or more when used in this application, including the claims. Thus, for example, reference to “a window” includes a plurality of such windows, and so forth.

Unless otherwise indicated, all numbers expressing quantities of elements, dimensions such as width and area, and so forth used in the specification and claims are to be understood as being modified in all instances by the term “about”. Accordingly, unless indicated to the contrary, the numerical parameters set forth in this specification and claims are approximations that can vary depending upon the desired properties sought to be obtained by the presently-disclosed subject matter.

As used herein, the term “about,” when referring to a value or to an amount of a dimension, area, percentage, etc., is meant to encompass variations of in some embodiments plus or minus 20%, in some embodiments plus or minus 10%, in some embodiments plus or minus 5%, in some embodiments plus or minus 1%, in some embodiments plus or minus 0.5%, and in some embodiments plus or minus 0.1% from the specified amount, as such variations are appropriate to perform the disclosed methods or employ the disclosed compositions.

The term “comprising”, which is synonymous with “including” “containing” or “characterized by” is inclusive or open-ended and does not exclude additional, unrecited elements or method steps. “Comprising” is a term of art used in claim language which means that the named elements are essential, but other elements can be added and still form a construct within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter. With respect to the terms “comprising”, “consisting of”, and “consisting essentially of”, where one of these three terms is used herein, the presently disclosed and claimed subject matter can include the use of either of the other two terms.

As used herein, the term “and/or” when used in the context of a listing of entities, refers to the entities being present singly or in combination. Thus, for example, the phrase “A, S, C, and/or O” includes A, S, C, and O individually, but also includes any and all combinations and subcombinations of A, S, C, and O.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. The foregoing disclosure and description are illustrative and explanatory thereof, and various changes in the details of the illustrated apparatus and construction and method of operation may be made without departing from the spirit in scope of the invention which is described by the following claims.

We claim:

1. An offshore submergible platform system comprising:
a floating platform, said floating platform having a top slab and side walls comprised of cast cementitious material and interior cells comprising a buoyant polymer;
a sea floor template/anchor slab comprising cast concrete, said seafloor template/anchor slab having a top surface and sides and being positioned on a sea floor below said floating platform with a top surface facing upwardly, said sea floor template/anchor having a plurality of block out openings;
a plurality of anchors, said anchors having a top end and a bottom end, the top end being affixed on to said floating platform and said bottom end extending through the block out openings of said sea floor template/anchor slab; and
a stub tower affixed the top slab of said floating platform extending upward from said floating platform for supporting work platforms above a surface of an ocean.

2. The system of claim 1 wherein the buoyant polymer of said floating platform comprises a plurality of polystyrene ingots having a generally cubical shape where the plurality of ingots are adjacent to each other between the platform side walls proximate to the top slab.

3. The system of claim 1 wherein the buoyant polymer comprises an open celled foam.

4. The system of claim 1 wherein the cementitious material of said floating platform comprises concrete.

5. The system of claim 1 wherein said anchors comprise tension legs.

6. The system of claim 1 wherein said anchors comprise drill pipe or casing.

7. The system of claim 1 wherein said anchors are grouted into holes in the ocean floor.

8. The system of claim 1 wherein said stub tower comprises concrete.

9. The system of claim 1 wherein said stub tower has a hollow interior filled with a buoyant polymer.

10. The system of claim 1 further comprising a wind mill tower affixed to said stub tower, said wind mill tower comprising a wind turbine.

11. The system of claim 10 wherein the wind mill tower further comprises an electric generator operated by the wind turbine.

12. The system of claim 1 further comprising a lifting crane affixed proximate to said stub tower.

13. The system of claim 1 further comprising a habitable platform affixed proximate to a top end of said stub tower, said habitable platform comprising living quarters and/or work areas.

14. The system of claim 1 further comprising a plurality of cable braces preferably forming an X shape by crossing between the floating platform and a bottom portion of said anchors.

15. A method of installing an offshore platform system comprising:
providing onshore a floating platform comprising cast cementitious material and a buoyant polymer said floating platform having a stub tower affixed to an upper portion of the floating platform and extending generally upward;
providing a template/anchor slab of cast cementitious material having a top surface and sides and being positioned on a sea floor below, said floating platform with a top surface facing upwardly, said template/anchor slab having a plurality of block out openings;
temporarily affixing said template/anchor slab beneath said floating platform;
towing the floating platform and template/anchor slab out to sea,
disconnecting the template/anchor slab from the floating platform and lowering the template slab in a desired position on the ocean floor;
securing a plurality of tension legs to the floating platform and the ocean floor; and
submerging the floating platform below an upper surface of the sea.

16. The method of claim 15 wherein the submerging step is performed using a modified lift slab technique.

17. The method of claim 15 wherein the lowering of the template/anchor slab is performed using a modified lift slab technique.

18. The method of claim 15 wherein said tension legs extend through the blockouts in said template/anchor slab and are grouted into holes in the ocean floor.
